(19) United States
(12) Patent Application Publication
(10) Pub. No.: US 2012/0079500 A1
(43) Pub. Date: Mar. 29, 2012

(54) PROCESSOR USAGE ACCOUNTING USING WORK-RATE MEASUREMENTS

(75) Inventors: Michael S. Floyd, Cedar Park, TX (US); Christopher Francois, Shakopee, MN (US); Naresh Nayar, Rochester, MN (US); Karthick Rajamani, Austin, TX (US); Freeman Leigh Rawson, III, Austin, TX (US); Randal C. Swanberg, Round Rock, TX (US)

(73) Assignee: INTERNATIONAL BUSINESS MACHINES CORPORATION, Armonk, NY (US)

(21) Appl. No.: 12/893,748

(22) Filed: Sep. 29, 2010

(51) Int. Cl. G06F 9/46

(52) U.S. Cl. 718/105

(57) ABSTRACT

Accounting charges are assigned to workloads by measuring a relative use of computing resources by the workloads, then scaling the results using determined work-rate for the corresponding workload. Usage metrics for the individual resources may be selectable for the resources being measured and the work-rates may be determined from an analytical model or from empirical model that determines work-rates from an indication of processor throughput. Under single workload conditions on a platform, or other suitable conditions, a workload type may be used to select the particular usage metrics applied for the various resources.

### BACKGROUND

1. Field of the Invention

The present invention is related to computer systems in which accounting for processor core and other resource usage within a computer system is performed.

2. Description of Related Art

In large scale computer systems, in particular in multi-user computer systems or so-called cloud computing systems in which multiple processors support multiple virtual operating systems and images, accounting for usage of computing resources is necessary in order to fairly charge for the use of the computing resources by individual workloads provided by multiple customers. Traditionally, in single-threaded and/or single processor systems, charges were made by the time required to complete a workload, since a workload was generally run as a single session, or if a scheduler did multiplex the computing resources between multiple workloads over a longer time period, the amount of time used by a workload could be accumulated and used to indicate the total usage of computing resources.

In present-day multi-threaded and multiprocessor systems, the relative resource usage by various workloads executing in the system are measured and provide a more accurate accounting of system resource usage by the various workloads and by the customers for which the workloads are executed.

### BRIEF SUMMARY

The invention is embodied in a method, a computer program product and a computer system, in which a work-rate measurement is used to scale results of a determination of relative resource usage by various workloads. The scaled result is used in computing accounting charges to assign to multiple workloads. The computer program product includes program instructions for carrying out the method and the computer system is a system that is managed according to the method.

The method measures relative use of computing resources within the computer system by the workloads, determines work-rates for the multiple workloads and computes accounting charges to assign to the workloads using the measured relative use of the computing resources and the determined work-rate for the corresponding workload.

The foregoing and other objectives, features, and advantages of the invention will be apparent from the following, more particular, description of the preferred embodiment of the invention, as illustrated in the accompanying drawings.

### BRIEF DESCRIPTION OF THE SEVERAL VIEWS OF THE DRAWING

The novel features believed characteristic of the invention are set forth in the appended claims. The invention itself, however, as well as a preferred mode of use, further objectives, and advantages thereof, will best be understood by reference to the following detailed description of the invention when read in conjunction with the accompanying Figures, wherein like reference numerals indicate like components, and:

FIG. 1 is a block diagram illustrating a computer system including in which techniques according to an embodiment of the present invention are practiced.

FIG. 2 is a block diagram illustrating details of processor cores 20A-20B in the computer system of FIG. 1.

FIG. 3 is a pictorial diagram showing details of information flow in a system in accordance with an embodiment of the present invention.

FIG. 4 is a flowchart of a method as performed in a computer system in accordance with an embodiment of the present invention.

### DETAILED DESCRIPTION

The present invention encompasses techniques for computing fair and accurate accounting charges for workloads executed by a processing system. Since workload throughput is affected by system conditions other than performance controls such as processor frequency and is not generally linear with variation in processor frequency or other performance controls, the techniques of the present invention scale indications of processor resource usage according to a work-rate factor. The techniques of the present invention measure an indication of computer system throughput and determine, either from an analytical model or an empirical model, the work-rate factor used to scale a measure of computer system resource usage for a workload. The resource usage is also a measured value and the indication used for measurement of the workload's usage of particular resources may be selected from among multiple usage indicators, such as instruction dispatches, instruction completions, memory bandwidth used by the workload threads, and other suitable indicators of a workload's drain on system resources. In general, the techniques of the present invention use the same metrics for concurrently executing workloads, in order to fairly account for system usage among multiple workloads and/or multiple customers. However, when a single workload is running on a platform, or under other suitable conditions, the particular usage indicators used to measure resource usage may be selected according to a type of the workload.

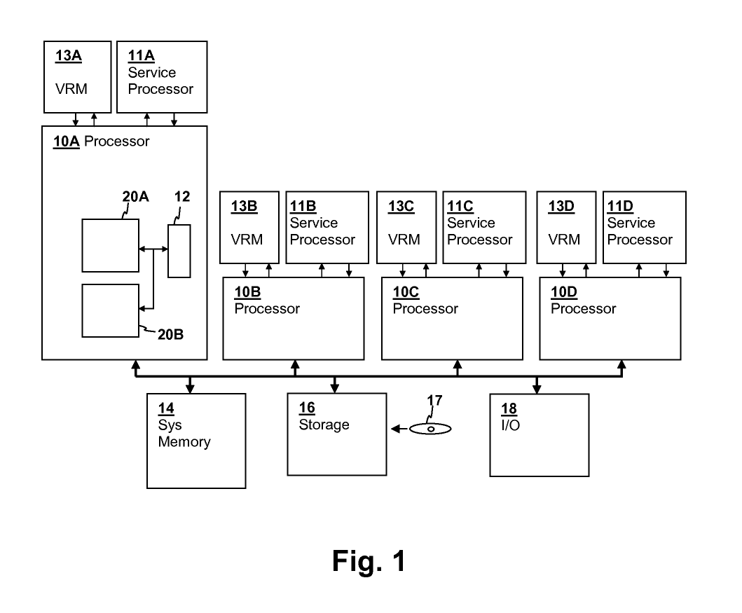

FIG. 1 shows a processing system in accordance with an embodiment of the present invention. The depicted processing system includes a number of simultaneous multi-threading (SMT) processors 10A-10D. The depicted multi-processing system is illustrative, and processing systems in accordance with other embodiments of the present invention will have different configurations. Processors 10A-10D are identical in structure and include cores 20A-20B and local storage 12, which may be a cache level, or a level of internal system memory. Processors 10A-10D are coupled to main system memory 14, a storage subsystem 16, which includes non-removable drives and optical drives, for reading media such as a CD-ROM 17 for loading program code for execution by processors 10A-10D. The illustrated processing system also includes input/output (I/O) interfaces and devices 18 such as mice and keyboards for receiving user input and graphical displays for displaying information. While the system of FIG. 1 is used to provide an illustration of a system in which the usage accounting methodology of the present invention is implemented, it is understood that techniques of the present invention can be implemented in other architectures. It is also understood that the present invention applies to other processors in accordance with embodiments of the present invention that may be used in a variety of system architectures.

The system of FIG. 1 provides power supply voltages to processors 10A-10D from corresponding voltage regulator modules (VRMs) 13A-13D. The output voltages of VRMs 13A-13D are programmable, so that different voltages can be supplied to each of processors 10A-10D. Corresponding service processors 11A-11D provide information for controlling corresponding VRMs 13A-13D, among other real-time control functions, and in the present embodiment execute program instructions that control the power supply voltages provided to processors 10A-10D and control the performance levels of cores 20A-20B within processors 10A-10D, by adjusting the clock frequency at which cores 20A-20B or by using another throttling mechanism such as controlling rates of instruction fetch or dispatch. Features of the exemplary system depicted in FIG. 1 are not limitations of the present invention, and other numbers of service processors 11A-11D and/or VRMs 13A-13D, as well as different ratios of service processors 11A-11D to VRMs 13A-13D are contemplated in accordance with alternative embodiments of the present invention. The performance control in the depicted embodiment provides for dynamic changes in the throughput of the depicted computer system for a given workload, and the performance control may be user-set, or automatically controlled to optimize performance while minimizing power consumption and/or maintaining thermal margins. Since the changes in the performance control(s) such as processor frequency have a non-linear effect on computer system throughput, accounting charges applied to a given workload under such conditions should take into account the varying throughput. The techniques of the present invention, provided by a computer program executed by one or more of processor cores 20A-20B as an application or operating system/hypervisor component, or alternatively by a computer program executed by one or more of service processors 11A-11B, determine a work-rate that is used to scale measured usage of the resources within the computer system of FIG. 1 by one or more workloads. A work-rate is determined for each workload in real-time using an indication of throughput and an analytical or empirical model that relates the throughput indication to a work-rate. The work-rate is then used to adjust a measure of computer system resource usage by the workload(s).

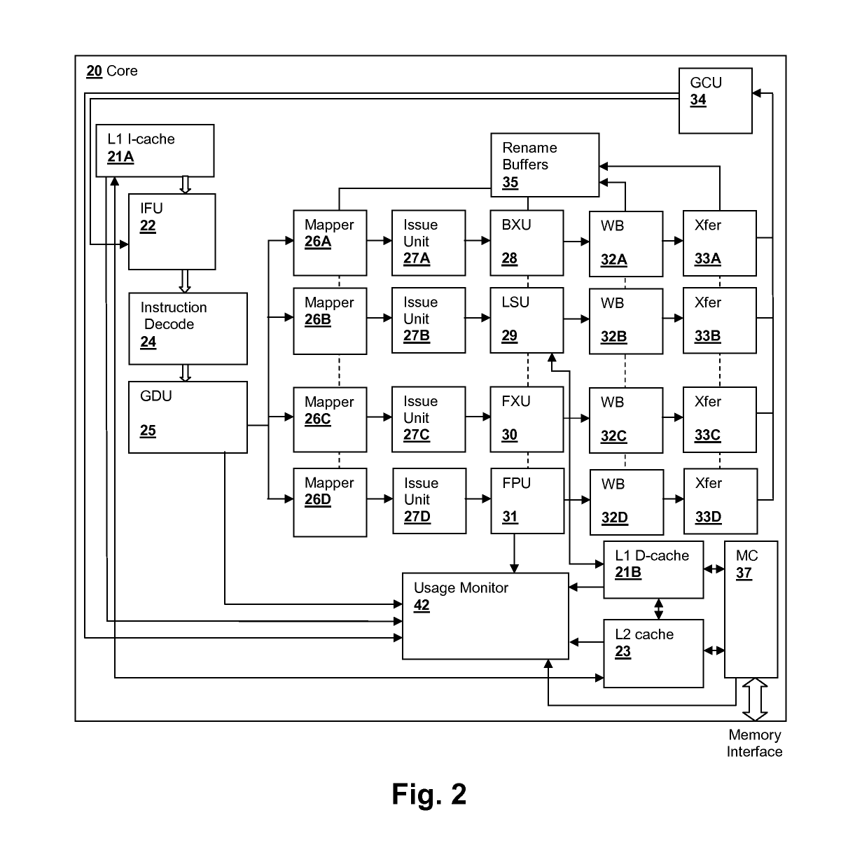

FIG. 2 illustrates details of a processor core 20 that can be used to implement processor cores 20A-20B of FIG. 1. Core 20 includes an instruction fetch unit (IFU) 22 that fetches instruction streams from L1 I-cache 21A, which, in turn receives instructions from an L2 cache 23. L2 Cache is coupled to a memory controller (MC) 37 that couples processor core 20 to a memory interface. Instructions fetched by IFU 22 are provided to an instruction decode unit 24. A global dispatch unit (GDU) 25 dispatches the decoded instructions to a number of internal processor pipelines. The processor pipelines each include a mapper 26A-26D, an issue unit 27A-27D, an execution unit, one of branch execution unit (BXU) 28, load/store unit (LSU) 29, fixed-point unit (FXU) 30 or floating point unit (FPU) 31, a write back unit (WB) 32A-32D and a transfer unit (Xfer) 33A-33D. A global completion unit (GCU) 34 provides an indication when result transfer is complete to IFU 22. Mappers 26A-26D allocate rename buffers 35 to represent registers or “virtual registers” indicated by instructions decoded by instruction decode unit 24 so that concurrent execution of program code can be supported by the various pipelines. Values in registers located in rename buffers are loaded from and stored to L1 D-cache 21B, which is coupled to L2 cache 23. Core 20 also supports out-of-order execution by using rename buffers 35, as mappers 26A-26D fully virtualize the register values. WBs 32A-32D write pipeline results back to associated rename buffers 35, and Xfers 33A-33D provide an indication that write-back is complete to GCU 34 to synchronize the pipeline results with the execution and instruction fetch process.

In illustrated core 20, signals indicative of occurrences of events indicative of resource usage and/or processor throughput are provided to a usage/performance monitor 42. Exemplary processor usage events in illustrated core 20 include instruction dispatches by GDU 25, instruction access cycles from L1 I-cache 21A and/or data access cycles from L1 D-cache 21B. Exemplary memory usage events include memory accesses indicated by memory controller MC 37. Exemplary throughput-indicating events include: instruction stall cycles from L2 cache 23, instruction completions from GCU 34, instruction stall cycles from FPU 31 and/or any other indications that produce throughput values such as processor clock cycles per instruction. As pointed out above, in order to provide a fair accounting for workload throughput, the present invention adjusts the result of a direct usage measurement, or alternatively a frequency-scaled usage measurement, using a determined work-rate.

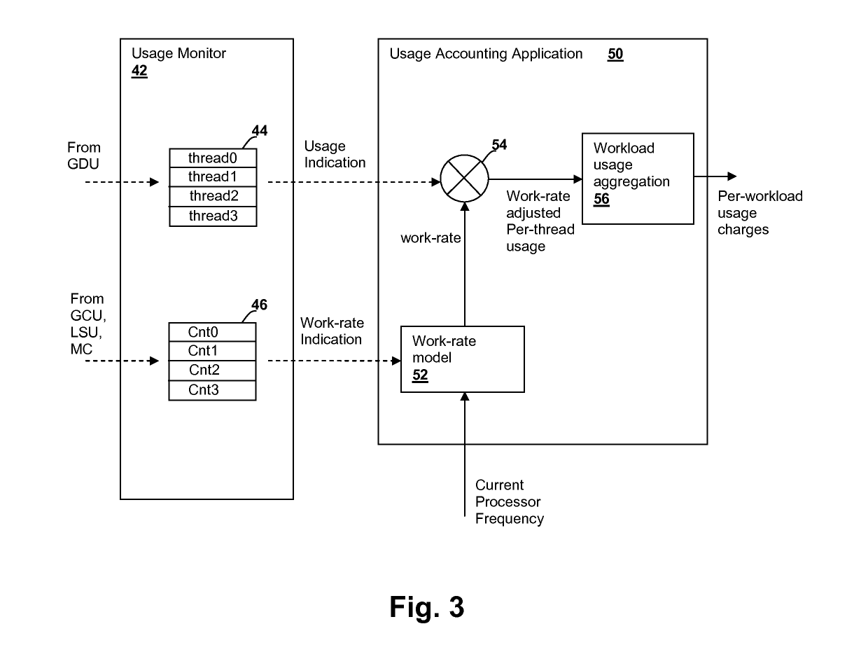

FIG. 3 shows information flow within the computer system of FIG. 1 in accordance with an embodiment of the present invention. In the depicted embodiment usage/performance monitor 42 provides per-thread usage counts 44 as a usage indication to a usage accounting application 50 executing within the computer system of FIG. 1 as described above. Usage/performance monitor 42 also provides work-rate indications 46 on a per-thread basis to usage accounting application 50. However, in accordance with an alternative embodiment of the invention, usage accounting application 50 can receive an aggregate indication of throughput over a period for all of the threads. Usage/performance monitor 42 also provides work-rate indications 46 to a work-rate model 52. Work-rate model 52 calculates a work-rate result used to scale the per-thread usage indication provided from usage/performance monitor 42 and the current processor frequency in a scaling operation 54. Workload usage aggregation block 56 aggregates the per-thread usage indications for the corresponding workloads during particular intervals and generates charges for the workloads. Workload usage aggregation block 56 may also aggregate the per-workload charges to determine per-customer charges. Workload usage aggregation block 56 receives scaled per-thread usage indications from multiple cores, so that the aggregated usage charges account for resource usage by all of the cores executing hardware threads for a given workload. Scaling operation 54 is only illustrative of one example of how the work-rate result provided from work-rate model 52 is applied. However, a person of ordinary skill in the art understands that there are many different ways to combine a usage indication and throughput indication to yield a per-thread usage adjusted for work-rate, such as two-dimensional look-up tables or computational algorithms.

One form of model that implements work-rate model 52, in accordance with an embodiment of the invention, is an analytical model that receives a measure of throughput and computes the work-rate result directly. The equations below express an example of such an analytical model, in which the work-rate result is a work-rate scale factor W determined from the ratio of instructions-per-second (IPS) at the current processor operating frequency f_{c} to the IPS at a nominal processor frequency fₙₒₘ:

W=IPS(f_{c})/IPS(fₙₒₘ)

If the cycles-per-instruction CPI can be determined for a workload during a measurement interval, then W stated in terms of CPI yields:

W=f_{c}/fₙₒₘ*CPI(fₙₒₘ)/CPI(f_{c})

The CPI for a workload has both a frequency dependent component CPI_{fdep}(f) and a frequency independent component CPI_{findep}, of which the CPI value is the sum:

CPI(f)=CPI_{findep}+CPI_{fdep}(f)

defining a CPI ratio according to:

CPIᵣₐₜᵢₒ(f)=CPI_{fdep}(f)/CPI_{findep}

and providing a linear model for the frequency-dependent portion of the CPI:

CPI_{fdep}(f)=f*K_{CPIfdep}

the resulting work-rate scaling factor W yields:

W=f_{c}/fₙₒₘ*CPI(fₙₒₘ)/CPI(f_{c})=f_{c}/fₙₒₘ*(1+CPIᵣₐₜᵢₒ(f_{c})*fₙₒₘ/f_{c})/(1+CPIᵣₐₜᵢₒ(f_{c})).

In one embodiment of the invention, run-time monitoring of dedicated performance counters that provide core stall statistics and memory hierarchy usage information as the processor core clock frequency changes provide input data for estimating the CPI ratio CPIᵣₐₜᵢₒ(f). Workloads having performance substantially bounded by the performance of the core, CPIᵣₐₜᵢₒ(f_{c}) will be close to zero W would be similar to the result provided by the processor clock frequency scaled model disclosed in above-incorporated U.S. Patent Application Publication 20080086395. However, for memory-bound workloads, CPIᵣₐₜᵢₒ(f_{c}) is much larger than unity, work-rate scale factor W is approximately 1.0 and a purely frequency-based scale factor, e.g., f_{c}/fₙₒₘ, yields erroneous results. Real workloads have work-rate factors that fall somewhere between the two extremes noted above.

Another work-rate model in accordance with an alternative embodiment of the invention provides a work-rate scaling factor W from look-up tables or a computational model that relates empirical data for a workload to the work-rate scaling factor. For example, work-rate model 52 may be provided by a look-up table that receives a count of instruction completions, memory stall cycles or other indication of throughput and also a current operating frequency input. From the input data, the table can provide an output work-rate value according to a range of the current operating frequency and throughput indication. The table may be pre-populated and set according to workload type in an alternative embodiment of the invention.

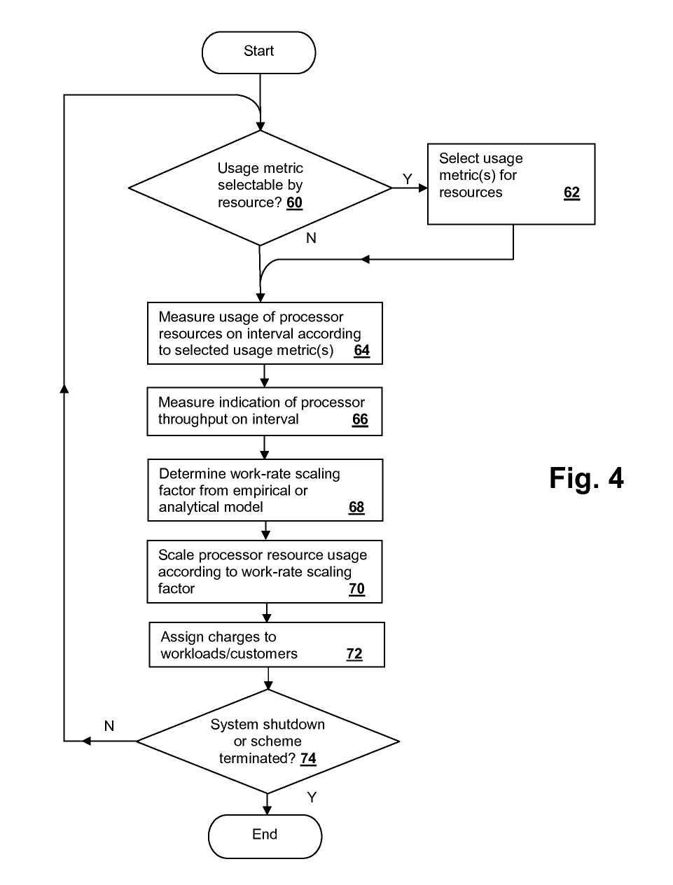

FIG. 4 illustrates a method in accordance with an embodiment of the present invention in a flowchart. If the usage metric used by the accounting algorithm is selectable (decision 60) then the method selects usage metrics for the corresponding resources for which usage is measured (step 62). The method next measures usage of processor resources on an interval according to the selected usage metrics (step 64) and indications of processor throughput are also measured (step 66). The computer program instructions for implementing the method of the present invention may perform the measuring by reading the per-thread usage counts 44 and the work-rate indications 46 as provided by usage/performance monitor 42 as described above. Work-rate scaling factors are determined from the analytical model or empirical model relating the throughput measure to the work-rate (step 68) and the processor resource usage is scaled according to the work-rate scaling factor (step 70). The method them allocates the resulting scaled resource usage to the workloads/clients as accounting charges (step 72). Until the measurement scheme terminates or the system shuts down (decision 74), the method repeats steps 60-74.

As noted above, all or portions of the present invention may be embodied in a computer program product, which may include firmware, an image in system memory or another memory/cache, or stored on a fixed or re-writable media such as an optical disc having computer-readable code stored thereon. Any combination of one or more computer readable medium(s) may store the program in accordance with an embodiment of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of the present application, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method of accounting for computing resource usage by multiple workloads executing within a computer system, the method comprising:
measuring a relative usage of computing resources within the computer system by the multiple workloads;
determining work-rates for the multiple workloads; and
computing accounting charges to assign to the multiple workloads in conformity with the corresponding measured relative usage of the computing resources for the workloads and the corresponding determined work-rate for the workloads.

2. The method of claim 1, wherein the computing accounting charges comprises:
computing the accounting charges for the multiple workloads from a result of the measuring a relative usage of the computing resources;
computing scaling factors from the determined work-rates for the multiple workloads; and
scaling the accounting charges for the multiple workloads according to the computed scaling factors.

3. The method of claim 1, wherein the measuring a relative usage of computing resources comprises:
selecting from among multiple selectable usage metrics for individual ones of the resources, wherein different usage metrics are selected for different resources; and
measuring the usage metrics selected for the workloads as the workloads are executed.

4. The method of claim 1, wherein the determining work-rates computes the work-rates from a current operating frequency and a nominal operating frequency of at least one processor core of the computer system using an analytical model that includes a processor frequency dependent work-rate term and a processor frequency independent work-rate term.

5. The method of claim 4, further comprising:
measuring at least one of a memory bandwidth usage and a memory stall count along with instruction throughputs for the multiple workloads to obtain processor frequency dependent and the processor frequency independent components of cycles-per-instruction rates for the multiple workloads; and
dynamically adjusting the work-rate terms in conformity the with cycles-per-instruction rates for the multiple workloads.

6. The method of claim 1, wherein the determining work-rates determines the work-rates using an empirical model of work-rate determined from a measured indication of throughput of the computer system for the corresponding workloads.

7. The method of claim 6, wherein the measured indication is one of an instruction completion rate, an instruction dispatch rate, an instruction fetch rate or a memory access rate.

8. A computer system comprising:
at least one processor; and
at least one memory coupled to the processor for storing program instructions for execution by the processor, wherein the program instructions comprise program instructions for accounting for computing resource usage by multiple workloads executing within the computer system, and wherein the processor measures a relative usage of computing resources within the computer system by the multiple workloads, determines work-rates for the multiple workloads, and computes accounting charges to assign to the multiple workloads in conformity with the corresponding measured relative usage of the computing resources for the workloads and the corresponding determined work-rate for the workloads.

9. The computer system of claim 8, wherein the processor further computes the accounting charges for the multiple workloads from a result of the measuring a relative usage of the computing resources, computes scaling factors from the determined work-rates for the multiple workloads, and scales the accounting charges for the multiple workloads according to the computed scaling factors.

10. The computer system of claim 8, wherein the processor measures the relative usage of computing resources by selecting from among multiple selectable usage metrics for individual ones of the resources, wherein different usage metrics are selected for different resources, and measuring the usage metrics selected for the workloads as the workloads are executed.

11. The computer system of claim 8, wherein the processor further determines work-rates by computing the work-rates from a current operating frequency and a nominal operating frequency of at least one processor core of the computer system using an analytical model that includes a processor frequency dependent work-rate term and a processor frequency independent work-rate term.

12. The computer system of claim 11, wherein the processor further measures at least one of a memory bandwidth usage and a memory stall count along with instruction throughputs for the multiple workloads to obtain processor frequency dependent and the processor frequency independent components of cycles-per-instruction rates for the multiple workloads, and dynamically adjusts the work-rate terms in conformity the with cycles-per-instruction rates for the multiple workloads.

13. The computer system of claim 8, wherein the processor determines the work-rates using an empirical model of work-rate determined from a measured indication of throughput of the computer system for the corresponding workloads.

14. The computer system of claim 13, wherein the measured indication is one of an instruction completion rate, an instruction dispatch rate, an instruction fetch rate, or a memory access rate.

15. A computer program product comprising a computer readable storage medium storing program instructions for execution by a processor within a computer system, wherein the program instructions comprise program instructions for accounting for computing resource usage by multiple workloads executing within the computer system, the program instructions comprising program instructions for:
measuring a relative usage of computing resources within the computer system by the multiple workloads;
determining work-rates for the multiple workloads; and
computing accounting charges to assign to the multiple workloads in conformity with the corresponding measured relative usage of the computing resources for the workloads and the corresponding determined work-rate for the workloads.

16. The computer program product of claim 15, wherein the program instructions for computing accounting charges comprise program instructions for:
computing the accounting charges for the multiple workloads from a result of the measuring a relative usage of the computing resources;
computing scaling factors from the determined work-rates for the multiple workloads; and
scaling the accounting charges for the multiple workloads according to the computed scaling factors.

17. The computer program product of claim 15, wherein the program instructions for measuring a relative usage of computing resources comprise program instructions for:
selecting from among multiple selectable usage metrics for individual ones of the resources, wherein different usage metrics are selected for different resources; and
measuring the usage metrics selected for the workloads as the workloads are executed.

18. The computer program product of claim 15, wherein the program instructions for determining work-rates compute the work-rates from a current operating frequency and a nominal operating frequency of at least one processor core of the computer system using an analytical model that includes a processor frequency dependent work-rate term and a processor frequency independent work-rate term.

19. The computer program product of claim 18, wherein the program instructions further comprise program instructions for:
measuring at least one of a memory bandwidth usage and a memory stall count along with instruction throughputs for the multiple workloads to obtain processor frequency dependent and the processor frequency independent components of cycles-per-instruction rates for the multiple workloads; and
dynamically adjusting the work-rate terms in conformity the with cycles-per-instruction rates for the multiple workloads.

20. The computer program product of claim 15, wherein the program instructions for determining work-rates determine the work-rates using an empirical model of work-rate determined from a measured indication of throughput of the computer system for the corresponding workloads.
